(19) United States
(12) Patent Application Publication
(10) Pub. No.: US 2019/0355060 A1
(43) Pub. Date: Nov. 21, 2019

(54) System and Method of AI Asset Exchange

(71) Applicant: CrowdCare Corporation, Richmond Hill (CA)

(72) Inventors: Ian Collins, Markham (CA); Jeffrey Brunet, Aurora (CA); Karthik Balakrishnan, Etobicoke (CA); Yousuf Chowdhary, King City (CA); Karen Chan, Richmond Hill (CA)

(73) Assignee: CrowdCare Corporation

(21) Appl. No.: 16/404,849

(22) Filed: May 7, 2019

Related U.S. Application Data
(60) Provisional application No. 62/672,134, filed on May 16, 2018.

(51) Int. Cl. G06Q 40/04; G06N 5/04; G06N 20/00

(52) U.S. Cl. CPC G06Q 40/04; G06N 20/00; G06N 5/04

(57) ABSTRACT

A computer-implemented system is provided for exchange of artificial intelligence (AI) assets through an AI asset exchange. The system includes a preprocessing engine programmed for receiving an AI asset by upload and preprocessing the AI asset for transaction by: anonymizing an owner/transactor of the AI asset; associating a set of identification and description parameters with the AI asset; associating a set of transaction terms with the AI asset; and associating a set of use terms with the AI asset. The system also includes a listing engine programmed for listing the preprocessed AI asset according to the identification and description parameters. The system also includes a transaction engine programmed for mediating a transaction of the AI asset according to the transaction terms. A method of preparing an artificial intelligence (AI) asset for transaction is also provided.

### FIELD OF INVENTION

The invention in general relates to artificial intelligence (AI) and in particular relates to providing a system for exchanging AI assets.

### BACKGROUND OF THE INVENTION

With the growth of artificial intelligence technologies, it has become an issue that companies that own or have developed AI models are not necessarily the same companies that have useful data sets for training these models. And companies with data sets who would like to work with AI models may lack access to available tools or internal resources to develop them. However, despite overlapping interests, at the present time, companies are left to find each other haphazardly, and privately contract to use each other's AI resources. There is a lack of available mechanisms or platforms to enable the common exchange of artificial intelligence (AI) assets developed by different entities; whether the AI asset exchange is for monetary gain or for open source resource development or for collaborative work.

It would be advantageous to have a mechanism for entities to benefit from AI resources developed by others to speed up the evolution of their own AI assets.

### SUMMARY

Broadly speaking, the present invention provides a method and a system of artificial intelligence (AI) asset exchange, where different entities can buy, sell, barter, exchange, collaborate etc. different AI assets.

It would be advantageous to have a mechanism to trade different AI assets whereby entities could benefit from the AI resources developed by others to speed up their own evolution. The system and method aims to provide a platform that acts like a stock exchange where AI assets can be bought and sold by different parties. The parties may have developed the AI assets themselves, or may possess rights to use those AI assets.

The AI Asset Exchange may be responsible for asset management, transaction management, rights and encryption key(s) management, data management, model management, grading of assets.

Artificial Intelligence (AI) aims to provide computing platforms that can perform intelligent human processes like reasoning, learning, problem solving, perception, language understanding etc. AI also aims to use computing to solve problems related to prediction, classification, regression, clustering, function optimization amongst a host of other problems.

The functionality of the AI Asset Exchange may be embedded in another platform. In another embodiment the functionality of the AI Asset Exchange of invention may be associated with a stock exchange where stock and commodities are traded using market-based pricing mechanisms like supply and demand.

An AI asset can be data or a model; and any AI asset can be bought, sold, rented, leased; fully (whole) or partially (a subset of the data, say 50%) bartered, exchanged, borrowed, collaborated on etc. An AI asset which is tangible (e.g. data or model) can be transacted, can be assigned value, can be graded by the system and rated by the user, can be extended or muted. The AI Asset Exchange can be responsible for asset management, transaction management, rights (encryption key) management, data management, model management, grading of assets.

Several examples of AI assets are described in the present application for illustration purposes, but the intent is to cover all such AI software, modules, models, algorithms etc. that may exist currently or will be developed or may evolve over time as a result of advancements in different fields of computing.

The system and method may also enable rights management of AI assets and control and enforce terms of transactions e.g. managing and enforcing the duration of the renting of an AI asset.

The system and method may also enable the unhindered handover of the AI assets being transacted between two or more entities so that the buyers and sellers are anonymized. In one embodiment of the invention the anonymization of the AI Assets may be at the AI asset exchange level. In other embodiments this process may be at the level of the buyers and sellers e.g. Entity A wants model trained and contracts Entity B. Entity B in turn uses Entity C and then Entity D. All entities are anonymized and none of them know who the others are.

The system and method may also enable the completion of the financial transaction as an agreement, or communication, carried out between a buyer and a seller to exchange an AI asset for a payment while the AI Asset Exchange may charge a fee for enabling the financial transaction.

A financial transaction involves a change in the status of the finances of two or more entities involved in the transaction. Preferably the buyer and seller are separate entities where a seller is an entity that is seeking to part with certain goods, while a buyer is an entity seeking to acquire the said goods being sold by the seller in exchange for an instrument of conveying a payment e.g. money. It will be appreciated that the terms “buyer” and “seller” are used here for convenience. Depending on the nature and terms of the AI asset transaction, the parties may be in a different relationship to each other (e.g. lessor/lessee, lender/borrower, auctioneer/bidder, bartering pairs or clusters, a chain of transaction parties in an ordered sequence, etc.). Further, an offering party may own an AI asset outright, or have rights to that asset, or be acting in the role of an agent or broker for another party that owns or has rights to that asset.

In one embodiment an AI asset is exchanged for a monetary instrument (e.g. money); in which case a completed transaction results in a debit in the finances of the purchaser and a credit in the finances of the sellers while the AI Asset Exchange may charge a fee for enabling the financial transaction. Cryptocurrency payments may be supported in some embodiments. Transactions involving non-monetary forms of exchange may also be supported (e.g. barter, trade, in-kind exchanges of other goods or services).

In certain embodiments, the financial transaction may be such that the AI asset and money are exchanged at the same time, simultaneously. In other embodiments the financial transaction may be such that the AI asset is exchanged at one time, and the money paid at another time. For example, payment may be in advance, or after the AI asset has been utilized e.g. after having trained an AI model for a period of ten days on a given set of data.

According to a first aspect of the invention, a computer-implemented system is provided for exchange of artificial intelligence (AI) assets through an AI asset exchange. The system includes a preprocessing engine programmed for receiving an AI asset by upload and preprocessing the AI asset for transaction by: anonymizing an owner/transactor of the AI asset; associating a set of identification and description parameters with the AI asset; associating a set of transaction terms with the AI asset; and associating a set of use terms with the AI asset. The system also includes a listing engine programmed for listing the preprocessed AI asset according to the identification and description parameters. The system also includes a transaction engine programmed for mediating a transaction of the AI asset according to the transaction terms.

The transaction engine may be further programmed for releasing the AI asset for use following the transaction (e.g. releasing the asset to the successful purchaser/bidder). Releasing the asset may or may not have the effect of removing the asset from the exchange.

The transaction engine may be further programmed for monitoring or tracking compliance with the use terms following the transaction.

In one case, the AI asset may be a data set. In this case, the preprocessing engine may be further programmed for anonymizing the data of the data set such that the data is not identifiable to a party receiving it. In one presently preferred embodiment, the anonymizing is by homomorphic encryption of the data set.

The parameters in this case may include the kind of data, the format of the data, the size of the data set or the bias of the data set.

The use terms may include at least one rights management stipulation.

The use terms may include at least one stipulation as to extension or muting of the data set.

In another case, the AI asset is an AI model/algorithm. In this case, the parameters may include the kind of model/algorithm, applicability or industry/vertical to be trained on.

The use terms may include training type, training mode or desired accuracy.

The parameters may include a training history of the model/algorithm. The parameters may also include a rating/grading of the AI asset.

A price may be associated with the AI asset prior to the listing. In some cases, the price is a transaction term set by the owner/transactor. In other cases, the price may be set by the AI asset exchange based on previous transactions of the AI asset or similar AI assets. The parameters may include a rating/grading of the AI asset, and in this case, the price may be a function of the rating/grading.

Preferably, the transaction terms include payment terms. The payment terms may include at least one of: payment in advance, payment at a particular milestone, payment at a particular time, payment on completion, or payment on return of the AI asset.

The use terms may include a given number of processing hops that are permitted with the AI asset.

According to a second aspect of the invention, a method is provided for preparing an artificial intelligence (AI) asset for transaction. The method includes the step of preprocessing the AI asset for transaction by: anonymizing an owner/transactor of the AI asset; associating a set of identification and description parameters with the AI asset; associating a set of transaction terms with the AI asset; and associating a set of use terms with the AI asset. The method also includes the step of uploading the preprocessed AI asset to an AI asset exchange to be listed according to the identification and description parameters, transacted according to the transaction terms, and released for use according to the use terms.

### BRIEF DESCRIPTION OF THE FIGURES

FIG. 1 is a flow diagram illustrating a basic process for an AI asset exchange (first part).

FIG. 2 is a flow diagram illustrating the basic process for an AI asset exchange (second part).

FIG. 3 is a logical diagram illustrating possible configurations of parties (entities) and assets mediated through the exchange.

FIG. 4 is a flow diagram of a more specific transaction mediated by an AI asset exchange (employing a time-limited loan/lease of an AI model for training).

FIG. 5 is a flow diagram of a more specific transaction mediated by an AI asset exchange (employing a loan/lease of data for training an AI model up to certain desired level of accuracy).

### DETAILED DESCRIPTION

Before embodiments of the invention are explained in detail, it is to be understood that the invention is not limited in its application to the details of the examples set forth in the following descriptions or illustrated drawings. It will be appreciated that numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein.

Furthermore, this description is not to be considered as limiting the scope of the embodiments described herein in any way, but rather as merely describing the implementation of the various embodiments described herein. The invention is capable of other embodiments and of being practiced or carried out for a variety of applications and in various ways. Also, it is to be understood that the phraseology and terminology used herein is for the purpose of description and should not be regarded as limiting.

Before embodiments of the software modules or flow charts are described in detail, it should be noted that the invention is not limited to any particular software language described or implied in the figures and that a variety of alternative software languages may be used for implementation of the invention.

It should also be understood that many components and items are illustrated and described as if they were hardware elements, as is common practice within the art. However, one of ordinary skill in the art, and based on a reading of this detailed description, would understand that, in at least one embodiment, the components comprised in the method and tool are actually implemented in software.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. Computer code may also be written in dynamic programming languages that describe a class of high-level programming languages that execute at runtime many common behaviours that other programming languages might perform during compilation. JavaScript, PHP, Perl, Python and Ruby are examples of dynamic languages.

The embodiments of the systems and methods described herein may be implemented in hardware or software, or a combination of both. However, preferably, these embodiments are implemented in computer programs executing on programmable computers each comprising at least one processor, a data storage system (including volatile and non-volatile memory and/or storage elements), and at least one communication interface. A computing device may include a memory for storing a control program and data, and a processor (CPU or GPU) for executing the control program and for managing the data, which includes user data resident in the memory and includes buffered content. The computing device may be coupled to a video display such as a television, monitor, or other type of visual display while other devices may have it incorporated in them (iPad, iPhone etc.). An application or an app or other simulation may be stored on a storage media such as a DVD, a CD, flash memory, USB memory or other type of memory media or it may be downloaded from the internet. The storage media can be coupled with the computing device where it is read and program instructions stored on the storage media are executed and a user interface is presented to a user. For example and without limitation, the programmable computers may be a server, network appliance, set-top box, SmartTV, embedded device, computer expansion module, personal computer, laptop, tablet computer, personal data assistant, game device, e-reader, or mobile device for example a Smartphone. Other devices include appliances having internet or wireless connectivity and onboard automotive devices such as navigational and entertainment systems.

The program code may execute entirely on a standalone computer, a server, a server farm, virtual machines, on the mobile device as a stand-alone software package; partly on the mobile device and partly on a remote computer or remote computing device or entirely on the remote computer or server or computing device. In the latter scenario, the remote computers may be connected to each other or the mobile devices through any type of network, including a local area network (LAN) or a wide area network (WAN), or the connection may be made to the internet through a mobile operator network (e.g. a cellular network); WiFi, Bluetooth etc.

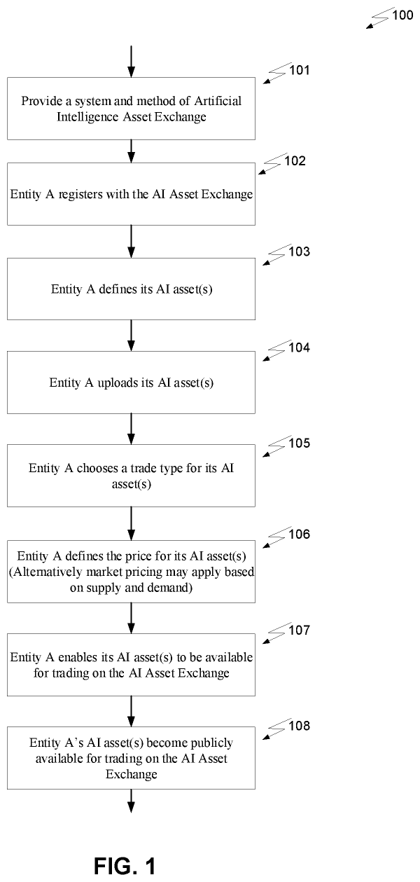

FIG. 1 above shows one embodiment in which a system and method is provided of an Artificial Intelligence Asset Exchange 101.

A method and a system of artificial intelligence (AI) asset exchange is provided where different entities can buy, sell, trade, barter, exchange, collaborate, borrow etc. different AI assets that they may have developed or possess rights to. The AI Asset Exchange may be responsible for asset management, transaction management, rights and encryption key(s) management, data management, model management, grading of assets.

Artificial Intelligence (AI) aims to provide computing platforms that can perform intelligent human processes like reasoning, learning, problem solving, perception, language understanding etc. AI also aims to use computing resources to solve problems related to prediction, classification, regression, clustering, and function optimization amongst a host of other problems.

The system and method of the invention aims to providing a platform that acts like a stock exchange where AI assets can be transacted by different parties.

In one embodiment the AI Asset Exchange may be embedded in another platform. In another embodiment the functionality of the AI Asset Exchange may be associated with a stock exchange where stock and commodities are traded using market-based pricing mechanisms like supply and demand.

In one sample process, Entity A registers with the AI Asset Exchange 102, adding information about the entity and its representatives to the system.

An AI asset can be data or a model; and any AI asset can be bought, sold, rented, leased, traded, borrowed, lent, donated, exchanged; fully (whole) or partially (a subset e.g. 50%). It is the objective of the present to cover all such methods and mechanisms that are used for transacting when two or more parties are involved e.g. a buyer and a seller. The list provided is exemplary and not meant to be exhaustive.

An AI asset that is tangible (e.g. data, algorithm, model) can be transacted, can be assigned value, can be graded by the system and rated by the system and/or users, can be extended or muted.

The AI Asset Exchange may be responsible for asset management, trade and financial transaction management, rights and encryption key(s) management, data management, model management, grading of assets amongst a host of other functions.

Preferably, Entity A defines its AI asset(s) 103. For example, if the AI asset is a data set, then Entity A may specify what kind of data is in the data set, its size, its bias. If the AI asset is an AI model, Entity A may specify what kind of AI model it is, its applicability, the industry or the vertical that it may be trained on etc. The system may also include automatic detection of some attributes of the data set or AI model on uploading. This may be used for definition/description of the AI asset or for validation of the entity's description of that asset.

Entity A uploads its AI asset(s) 104.

Entity A chooses a trade type for its AI asset(s) 105, e.g. chooses to rent it to any other entity that may gain advantage from it.

Entity A defines the price for its AI asset(s) 106, e.g. rent for its asset could be a given number of units of a given currency.

Entity A enables its AI asset(s) to be available for trading on the AI Asset Exchange 107.

Entity A's AI asset(s) become publicly available for trading on the AI Asset Exchange 108. For example, Entity A's AI asset(s) may be publicly available for trading on the AI Asset Exchange such that any member of the public can browse the availability (listing). In other embodiments, browsing and transacting may be limited to those entities who are registered with or otherwise valid participants in the AI Asset Exchange.

Preferably, the present method and system of AI asset transaction is adaptable to a varied set of AI items so that different entities may be enabled to synthesize solutions from a wide set of AI sources that are chained together for performing complex computing tasks and are sourced from the AI Exchange.

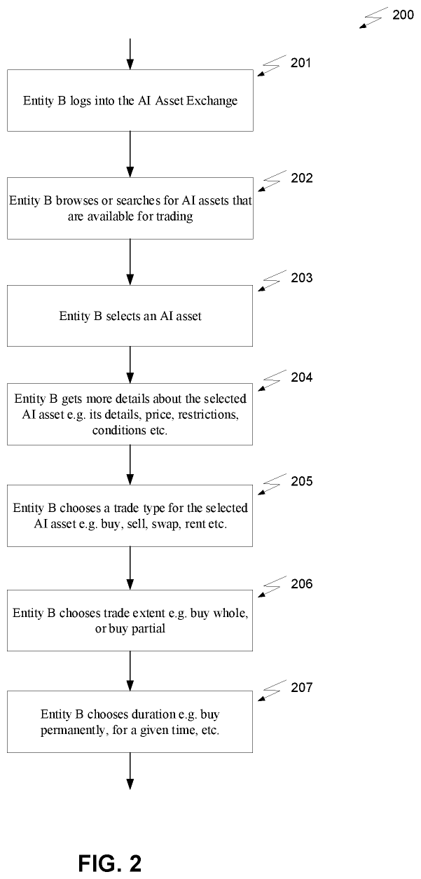

FIG. 2 shows one embodiment 200. Entity B logs into the AI Asset Exchange 201. In some embodiments an entity may not be required to login to browse or search the AI Assets that are listed with the AI Asset Exchange for trading.

Entity B browses or searches for an AI asset that are available for trading 202.

Entity B selects an AI asset 203.

Entity B gets more details about the selected AI asset e.g. its details, price, restrictions, conditions etc. 204.

Entity B chooses a trade type for the selected AI asset e.g. buy, sell, swap, rent etc. 205. In one embodiment of the invention Entity B chooses a trade type for the selected AI asset e.g. buy, sell, swap, rent etc. The trade type may be keyed to a set of pre-existing transaction terms, or these may be set/negotiated in whole or in part by the parties.

Entity B chooses trade extent e.g. buy whole, or partial 206.

Entity B chooses duration e.g. buy permanently, for a given time (e.g. a month), etc. 207.

The present system and method may also provide rights management of the AI assets to control and enforce the transactions. For example, if a dataset or a model was rented or leased for a duration of 5 days, then the system may automatically expire the encryption keys after that duration to enforce the agreement. This enables transactions like renting data for a duration, buying a portion of a data set, buying a given number of hops of data training from different entities for model training, each hop may have a notion of limited time (renting for a duration) and data size (train on a part of data set or whole data set) associated with it.

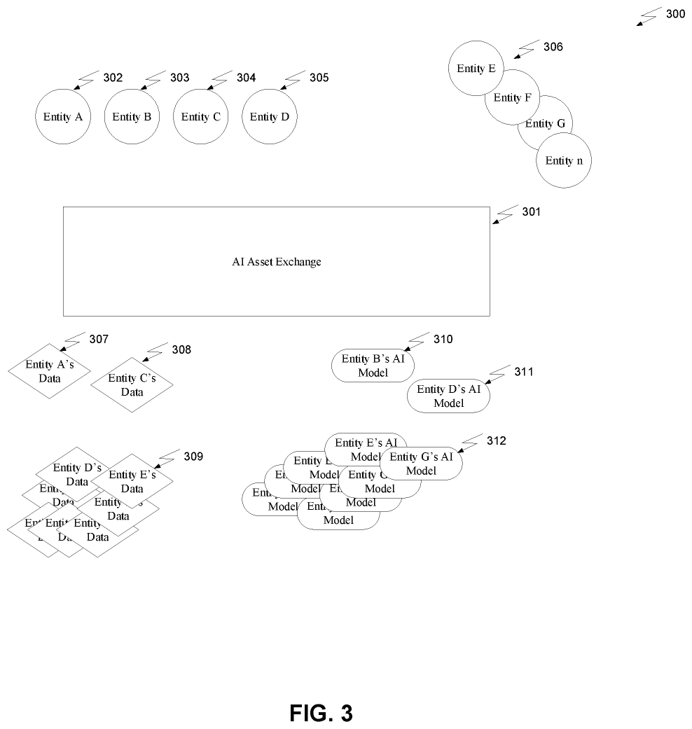

FIG. 3 shows one embodiment 300. The figure depicts a logical view of the AI Asset Exchange 301 and the different entities and the AI assets they may own or have rights to transact.

Entity A 302 owns or has rights to Entity A's Data 307. Entity B 303 owns or has rights to Entity B's AI Model 310. Entity C 304 owns or has rights to Entity C's Data 308. Entity D 305 owns or has rights to Entity D's AI Model 311.

Similarly, other entities 306 (Entity E, Entity F, Entity G to Entity n) have rights to transact Data sets 309 and AI Models 312.

AI Models may include but are not limited to Decision Trees, Linear Regression Models, Support Vector Machines, Artificial Neural Networks and the like. Artificial Neural Systems is an approach to AI where the system aims to model the human brain, simple processes are interconnected in a way that they simulate the connection of the nerve cells in the human brain, and the output from the ANS is compared with the expected output and the processors can be retrained.

AI assets may include reasoning related items e.g. non-monotonic reasoning, model-based reasoning, constraint satisfaction, qualitative reasoning, uncertain reasoning, temporal reasoning, heuristic searching etc.

AI assets may include Machine Learning related items e.g. evolutionary computation, case-based reasoning, reinforcement learning, neural network, data analysis etc.

AI assets may include Knowledge Management related items e.g. logic, multiagent systems, decision support system, knowledge management, knowledge representation, ontology and semantic web, computer-human interaction etc.

AI assets may include items related to robotics, perception, and natural language processing related; robotics and control, artificial vision including sensing and recognizing images, speech recognition, speech synthesis etc.

Natural Language Processing and Speech Recognition include AI systems that can be controlled and respond to human verbal commands, including classification, machine translation, question answering, text and speech generation, speech including speech-to-text, text-to-speech, speech synthesis etc.

Vision systems may include computing that may be used to sense, recognize and make sense of images, comparisons to Knowledge Base, pattern matching and understanding objects, including systems for image recognition, machine vision and the like.

Machine Learning (ML) may include deep learning, supervised and unsupervised learning, robotics, expert systems, and planning.

Natural Language Understanding (NLU) may include subtopic in Natural Language Processing (NLP) which focus on how to best handle unstructured inputs such as text (spoken or typed) and convert them into a structured form that a machine can understand and act upon. The result of NLU is a probabilistic understanding of one or more intents conveyed, given a phrase or sentence. Based on this understanding, an AI system may then determine an appropriate disposition.

Natural Language Generation on the other hand, is the NLP task of synthesizing text-based content that can be easily understood by humans, given an input set of data points. The goal of NLG systems is to figure out how to best communicate what a system knows. In other words, it is the reverse process of NLU.

Generative Neural Nets or Generative Adversarial Networks (GAN) is an unsupervised learning technique where given samples of data (e.g. images, sentences) an AI system can then generate data that is similar in nature. The generated data should not be discernable as having been artificially synthesized.

Some language-related AI processes and systems with specific application to customer care are described for example in applicants' prior patent application Ser. Nos. 15/152,394; 16/203,756; 16/262,176, the disclosures of which are incorporated herein by reference.

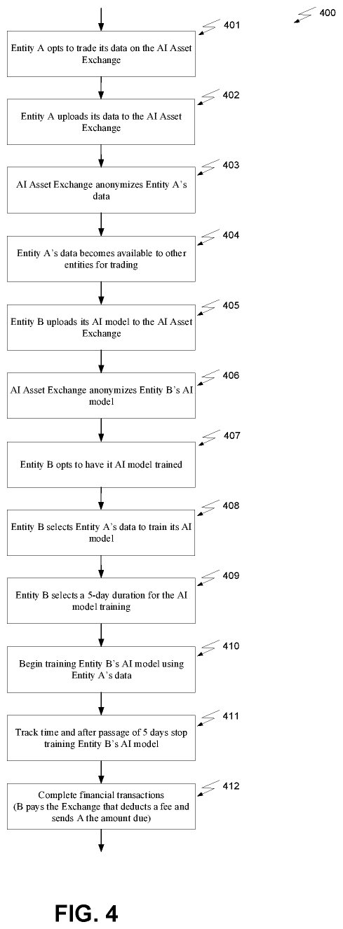

FIG. 4 shows one embodiment of the invention 400. Entity A opts to trade its data on the AI Asset Exchange 401.

Entity A uploads its data to the AI Asset Exchange 402.

The AI Asset Exchange anonymizes Entity A's data 403. For example, the data may be anonymized using techniques such as homomorphic encryption.

Homomorphic encryption is a method of performing calculations on encrypted information without decrypting it first. Homomorphic encryption allows computation on encrypted data and may produce results that are also encrypted.

Homomorphic encryption can also be used to securely chain together different services without exposing sensitive data or the AI model to any of the participants in the chain. For example, Entity A's model can be used to produce a result after interacting with Entity B's encrypted data set. In this case homomorphic encryption prevents Entity A from knowing what Entity B's data is and also prevents Entity B from knowing anything about Entity A's AI model.

Thus, homomorphic encryption enables entities to chain together in providing a final solution without exposing the unencrypted data or the AI model to each of those entities participating in the chaining process.

The present system and method enables the smooth handover of the AI assets being transacted between two or more entities. Preferably, the buyers and sellers are anonymized. The anonymization of the AI Assets may be at the AI asset exchange level. This process may also be at the level of the buyers and sellers e.g. Entity A wants model trained and contracts Entity B. Entity B in turn uses Entity C and then Entity D, thus the system and method of invention ensures that all entities are anonymized and none of the participants in a transaction know who the others entities are.

Entity A's data becomes available to other entities for trading 404, preferably in an encrypted form.

Entity B uploads its AI model to the AI Asset Exchange 405.

AI Asset Exchange anonymizes Entity B's AI model 406, e.g. by using techniques like homomorphic encryption.

Entity B opts to have it AI model trained 407. Model training may include but is not limited to Example Collection, Example Generation, Example Curation, Training/Validation/Test Sets, Loss/Error and Update Model etc.

The Training Modes may include but are not limited to Supervised and Unsupervised learning, Reinforcement learning, Online learning i.e. learn as you go, or other modes.

Entity B selects Entity A's data to train its AI model 408, using one or a combination of several training modes.

Entity B selects a 5-day duration for the AI model training 409, preferably using a given training mode.

The system initiates the training of Entity B's AI model using Entity A's data 410, e.g. in the required training mode.

The system preferably tracks the time and after passage of 5 days stops training Entity B's AI model 411.

The system negotiates any outstanding financial transactions 412, including any payment terms set or agreed to as between the parties while the AI Asset Exchange may charge a fee for enabling the financial transaction.

In one embodiment the financial transaction may be such that the AI asset and money are exchanged at the same time, simultaneously. In another embodiment a financial transaction may be such that the AI asset is exchanged at one time, and the money at another for example in one case the money is paid in advance, while in another case the money is paid after the AI asset has been utilized e.g. payment is made after having trained an AI model for a period of ten days on a given set of data.

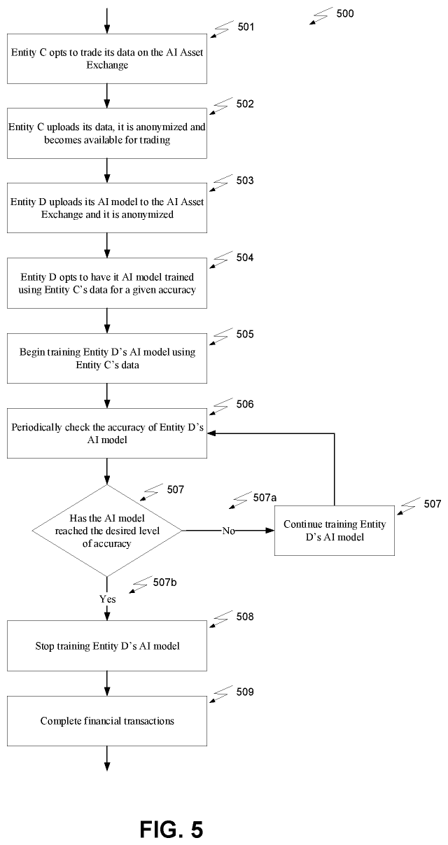

FIG. 5 shows one embodiment of the invention 500. Entity C opts to trade its data on the AI Asset Exchange 501. In one embodiment of the invention Entity C opts to trade its data on the AI Asset Exchange.

Entity C uploads its data, it is anonymized (e.g. through homomorphic encryption techniques) and becomes available for trading 502.

Entity D uploads its AI model to the AI Asset Exchange and it is anonymized (e.g. through homomorphic encryption techniques) 503.

Entity D opts to have its AI model trained using Entity C's data for a given accuracy 504, e.g. reaching a certain level of performance or achieving results in a given time constraint amongst other requirements.

The system initiates the training of Entity D's AI model using Entity C's data 505. In one embodiment the system may periodically check the accuracy of Entity B's AI model as it begins training Entity D's AI model using Entity C's data. At the start of the training an accuracy check may be done to measure the extent of previous training that the model may have already received and further accuracy checks may be done as it continues to train the AI model.

The system continues training of the AI model and periodically checking the accuracy of the Entity D's AI model 506. The system checks whether the AI model has reached the desired level of accuracy 507.

If No 507a, the AI model has not reached the desired level of accuracy, then the system continues to train the model and periodically check its accuracy. If Yes 507b, the AI model has reached the desired level of accuracy, then the system stops training Entity D's AI model 508. In one embodiment of the invention after the training is stopped, the system informs Entity D that its model has been trained to the desired accuracy.

The system negotiates any outstanding financial transactions 509. In one embodiment of the invention complete financial transaction by effecting a change in the status of the finances of buyer and the seller while deducting a fee for the services provided by the AI Asset Exchange for enabling this process.

In one embodiment of the invention complete financial transaction between the buyer of the AI asset and the seller of the AI asset by decreasing the finances of the purchaser and increasing the finances of the sellers and preferably the AI Asset Exchange deducts a fee from the amount paid by the seller for enabling the said financial transaction.

The program code may execute entirely on a computing device like a server, a cluster of servers, computing devices that are physical or virtual, or a server farm; partly on a physical server and partly on a virtual server. The different computing devices may be connected to each other through any type of network, including a local area network (LAN) or a wide area network (WAN), or the connection may be made to the internet through a mobile operator network (e.g. a cellular network).

Several exemplary embodiments/implementations of the invention have been included in this disclosure. There may be other methods obvious to the ones skilled in the art, and the intent is to cover all such scenarios. The application is not limited to the cited examples, but the intent is to cover all such areas that may benefit from this invention. The above examples are not intended to be limiting but are illustrative and exemplary.

What is claimed is:

1. A computer-implemented system for exchange of artificial intelligence (AI) assets through an AI asset exchange, comprising:
a preprocessing engine programmed for receiving an AI asset by upload and preprocessing the AI asset for transaction by:
anonymizing an owner/transactor of the AI asset;
associating a set of identification and description parameters with the AI asset;
associating a set of transaction terms with the AI asset;
associating a set of use terms with the AI asset; and
a listing engine programmed for listing the preprocessed AI asset according to the identification and description parameters; and
a transaction engine programmed for mediating a transaction of the AI asset according to the transaction terms.

2. The system of claim 1, wherein the transaction engine is further programmed for releasing the AI asset for use following the transaction.

3. The system of claim 1, wherein the transaction engine is further programmed for monitoring or tracking compliance with the use terms following the transaction.

4. The system of claim 1, wherein the AI asset is a data set.

5. The system of claim 4, wherein the preprocessing engine is further programmed for anonymizing the data of the data set such that the data is not identifiable to a party receiving it.

6. The system of claim 5, wherein the anonymizing is by homomorphic encryption of the data set.

7. The system of claim 4, wherein the parameters include the kind of data, the format of the data, the size of the data set or the bias of the data set.

8. The system of claim 4, wherein the use terms include at least one rights management stipulation.

9. The system of claim 4, wherein the use terms include at least one stipulation as to extension or muting of the data set.

10. The system of claim 1, wherein the AI asset is an AI model/algorithm.

11. The system of claim 10, wherein the parameters include the kind of model/algorithm, applicability or industry/vertical to be trained on.

12. The system of claim 10, wherein the use terms include training type, training mode or desired accuracy.

13. The system of claim 10, wherein the parameters include a training history of the model/algorithm.

14. The system of claim 1, wherein the parameters include a rating/grading of the AI asset.

15. The system of claim 1, wherein a price is associated with the AI asset prior to the listing.

16. The system of claim 15, wherein the price is a transaction term set by the owner/transactor.

17. The system of claim 15, wherein the price is set by the AI asset exchange based on previous transactions of the AI asset or similar AI assets.

18. The system of claim 15, wherein the parameters include a rating/grading of the AI asset, and wherein the price is a function of the rating/grading.

19. The system of claim 1, wherein the transaction terms include payment terms.

20. The system of claim 19, wherein the payment terms include at least one of: payment in advance, payment at a particular milestone, payment at a particular time, payment on completion, or payment on return of the AI asset.

21. The system of claim 1, wherein the use terms include a given number of processing hops that are permitted with the AI asset.

22. A method of preparing an artificial intelligence (AI) asset for transaction, comprising the steps of:
preprocessing the AI asset for transaction by:
anonymizing an owner/transactor of the AI asset;
associating a set of identification and description parameters with the AI asset;
associating a set of transaction terms with the AI asset;
associating a set of use terms with the AI asset; and
uploading the preprocessed AI asset to an AI asset exchange to be listed according to the identification and description parameters, transacted according to the transaction terms, and released for use according to the use terms.
